(19) United States
(12) Patent Application Publication
(10) Pub. No.: US 2021/0388150 A1
(43) Pub. Date: Dec. 16, 2021

(54) A PROCESS FOR PRODUCING A POLYURETHANE ELASTOMER

(71) Applicant: Covestro Intellectual Property GmbH & Co. KG, Leverkusen (DE)

(72) Inventors: Jun Tong, Pudong, Shanghai (CN); Guobin Sun, Pudong, Shanghai (CN)

(21) Appl. No.: 17/287,147

(22) PCT Filed: Nov. 12, 2019
(86) PCT No.: PCT/EP2019/080921

§ 371 Date: Apr. 21, 2021

(30) Foreign Application Priority Data
Nov. 19, 2018 (CN) 201811381672.6
Jan. 14, 2019 (EP) 19151584.0

(51) Int. Cl. C08G 18/48; C08G 18/24; C08G 18/32

(52) U.S. Cl. CPC C08G 18/4833; C08G 2120/00; C08G 18/324; C08G 18/242

(57) ABSTRACT

The present invention relates to a process for producing a polyurethane elastomer, a polyurethane elastomer produced by the process, and the use of the polyurethane elastomer in a glass encapsulation/elastic gasket or the like. The process mainly includes adding a hindered amine light stabilizer to the isocyanate-containing component A. Its reaction with the organotin catalyst in the isocyanate reactive component (i.e. component B), which may cause a loss of the catalytic performance of the catalyst, is avoided. The curing speed of the polyurethane elastomer is increased, thereby the production efficiency is improved and costs are reduced.

### TECHNICAL FIELD

The present invention relates to a process for producing a polyurethane elastomer, a polyurethane elastomer produced by the process, and the use of the polyurethane elastomer in a glass encapsulation and an elastic gasket or the like.

### PRIOR ART

A polyurethane elastomer, as a kind of polyurethane materials, is widely used in all fields of the production and our life. In a process for producing a polyurethane elastomer well known in the art, the polyurethane reaction injection molding process (RIM) can be employed. The polyurethane elastomer obtained by the reaction injection molding process can be used for producing glass encapsulation seals, elastomer gaskets, energy absorbing bumpers for luxury automobiles and other products. However, aromatic isocyanate-based polyurethane products may usually discolor due to long-term absorption of ultraviolet rays of the sunlight when employed in an outdoor environment, thereby accompanied by a decrease in mechanical properties. For this purpose, a light stabilizer such as a hindered amine light stabilizer is usually added to the component B of the polyurethane reaction system. In the polyurethane elastomers by reaction injection molding, the polyurethane catalyst of organotin class is widely used because it can help rapid curing. However, when a hindered amine light stabilizer is combined with a polyurethane catalyst of organotin class such as an alkyltin thiolate, an alkyltin mercaptoacetate and a long-chain alkyltin carboxylate, a coordination/complex may be formed. It may make the catalyst of the isocyanate reaction system being inefficient/deactivated. At present, a common possibility to avoid said drawback is adding one of hindered amine light stabilizers and some organotin catalysts as a third component to the isocyanate reactive component in situ, resulting in a more complicated process. Nevertheless, when the catalysts are combined with the hindered amine auxiliary in the isocyanate reactive component, the catalysts may still be deactivated and inefficient within a short period of time (within dozens of minutes or several hours), thereby affecting the production efficiency and product quality.

U.S. Pat. No. 6,242,555 discloses a process for producing a light-stable polyurethane elastomer. The process includes reacting an isocyanate component A with an isocyanate reactive component B comprising components such as a polyol, a chain extender, a catalyst and a light stabilizer to obtain the polyurethane elastomer.

CN101768251A discloses a polyurethane elastomer for automobile glass encapsulation and a process for producing the same. The elastomer is produced by a reaction injection molding process from an isocyanate component A and a polyol component B, and has a density of more than 1000 kg/m3 and an isocyanate index of 0-120, wherein the component A is a NCO-terminated prepolymer having NCO % of 18-28%, which is a reaction product of aromatic diisocyanate and low-molecular-weight polyol; component B comprises at least 60% of polyether polyol with a molecular weight of 1000-10000, 1-20% of aromatic amine, 0-20% of alcohol, 0.2-5.0% of composite catalyst, and also an antioxidant, a light stabilizer and a color paste. The polyurethane elastomer of the invention has excellent mechanical properties and moderate aging resistance, and is suitable for the encapsulation of vehicle window glass with various specifications, especially for large, ultra-thin or complex products.

Despite the above disclosures, a storage-stable polyurethane elastomer reaction system, as well as a highly efficient process for producing a polyurethane elastomer, are urgently needed in applications such as glass encapsulations and elastic gaskets.

### SUMMARY OF THE INVENTION

One aspect of the present invention provides a process for producing a polyurethane elastomer, comprising producing the polyurethane elastomer by reacting a reaction system comprising the following components:

a component A, comprising:
A1) one or more isocyanates;
A2) at least one hindered amine light stabilizer in a content of 0.25-8.0 pbw, preferably 0.75-7.5 pbw, particularly preferably 1.2-7.0 pbw, based on the total weight of the component A;

a component B, comprising:
B1) an EO-terminated long-chain polyether polyol having a functionality of 3, a hydroxyl value of 17.5-35.5 mgKOH/g, preferably 22.5-35.5 mgKOH/g, and a weight average molecular weight of 4800-10000 g/mol, preferably 4800-8000 g/mol (as determined according to GB/T 21863-2008) in a content of 30-85 pbw, based on the total weight of the component B;
B2) optionally an EO-terminated long-chain polyether polyol having a functionality of 2, a hydroxyl value of 14.0-62.0 mgKOH/g, preferably 18.5-56.0 mgKOH/g, and a weight average molecular weight of 1800-8000 g/mol, preferably 2000-6000 g/mol (as determined according to GB/T 21863-2008) in a content of 0-55 pbw, preferably 1-50 pbw, based on the total weight of the component B;
B3) a catalyst, comprising B3-1) at least one organotin catalyst.

The hindered amine light stabilizer is preferably selected from one, two or more of the group consisting of (2,2,6,6-tetramethyl-4-hydroxypiperidyl) benzoate, bis(2,2,6,6-tetramethyl-4-hydroxypiperidyl) sebacate, nitrilo-tris[(2,2,6,6-tetramethyl-4-hydroxypiperidyl) acetate] and N,N′-bis(2,2,6,6-tetramethylpiperidyl) hexamethylenediamine, tris(1,2,2,6,6-pentamethyl-4-hydroxypiperidyl) phosphite, bis(1,2,2,6,6-pentamethyl-4-hydroxypiperidyl) sebacate, bis(1,2,2,6,6-pentamethyl-4-hydroxypiperidyl) 2-ethyl-2-(4-hydroxy-3,5-di-tert-butylbenzyl)malonate and combinations thereof.

B3-1) the organotin catalyst is preferably selected from one, two or more of the group consisting of alkyltin thiolates, alkyltin mercaptoacetates and long-chain alkyltin carboxylates. The organotin catalyst has a content of 0.01-0.5 pbw, preferably 0.01-0.3 pbw, based on the total weight of the component B.

The component B preferably further comprises B4) at least one low-molecular-weight polyol/alcohol amine chain extender in a content of 2.0-15.0 pbw, preferably 3.5-13.5 pbw, based on the total weight of the component B.

The component B preferably further comprises B5) a polyether polyol started with ethylene diamine having a hydroxyl value of 330-800 mgKOH/g, a molecular weight of 250-800 g/mol (as determined according to GB/T 21863-2008) in a content of 0.5-7.5 pbw, based on the total weight of the component B.

The component B preferably further comprises B6) a color paste in a content of 0.1-5.0 pbw, based on the total weight of the component B.

Optionally, the component B further comprises B7) a silicone surfactant in a content of 0.05-0.5 pbw, based on the total weight of the component B.

Optionally, the mass ratio of the component A to the component B in the reaction system is 35-80:100, preferably 40-75:100.

The process is preferably a reaction injection molding process.

Another aspect of the present invention provides a polyurethane elastomer obtained by the aforementioned process of the present invention, which is produced from a reaction system comprising the following components:
a component A, comprising:
   A1) one or more isocyanates;
   A2) at least one hindered amine light stabilizer in a content of 0.25-8.0 pbw, preferably 0.75-7.5 pbw, particularly preferably 1.2-7.0 pbw, based on the total weight of the component A;
a component B, comprising:
   B1) an EO-terminated long-chain polyether polyol having a functionality of 3, a hydroxyl value of 17.5-35.5 mgKOH/g, preferably 22.5-35.5 mgKOH/g, and a weight average molecular weight of 4800-10000 g/mol, preferably 4800-8000 g/mol (as determined according to GB/T 21863-2008) in a content of 30-85 pbw, based on the total weight of the component B;
   B2) optionally an EO-terminated long-chain polyether polyol having a functionality of 2, a hydroxyl value of 14.0-62.0 mgKOH/g, preferably 18.5-56.0 mgKOH/g, and a weight average molecular weight of 1800-8000 g/mol, preferably 2000-6000 g/mol (as determined according to GB/T 21863-2008) in a content of 0-55 pbw, preferably in a content of 1-50 pbw, based on the total weight of the component B;
   B3) a catalyst, comprising at least one organotin catalyst.

A2) the hindered amine light stabilizer is preferably selected from one, two or more of the group consisting of (2,2,6,6-tetramethyl-4-hydroxypiperidyl) benzoate, bis(2,2,6,6-tetramethyl-4-hydroxypiperidyl) sebacate, nitrilo-tris[(2,2,6,6-tetramethyl-4-hydroxypiperidyl) acetate] and N, N′-bis(2,2,6,6-tetramethylpiperidyl) hexamethylenediamine, tris(1,2,2,6,6-pentamethyl-4-hydroxypiperidyl) phosphite, bis(1,2,2,6,6-pentamethyl-4-hydroxypiperidyl) sebacate, bis(1,2,2,6,6-pentamethyl-4-hydroxypiperidyl) 2-ethyl-2-(4-hydroxy-3,5-di-tert-butylbenzyl)malonate and combinations thereof.

The component B preferably further comprises B4) at least one low-molecular-weight polyol/alcohol amine chain extender in a content of 2.0-15.0 pbw, preferably 3.5-13.5 pbw, based on the total weight of the component B.

The component B preferably further comprises B5) a polyether polyol started with ethylene diamine having a hydroxyl value of 330-800 mgKOH/g, a molecular weight of 250-800 g/mol (as determined according to GB/T 21863-2008) in a content of 0.5-7.5 pbw, based on the total weight of the component B.

The component B preferably further comprises B6) a color paste in a content of 0.1-5.0 pbw, based on the total weight of the component B.

Optionally, the component B further comprises B7) a silicone surfactant in a content of 0.05-0.5 pbw, based on the total weight of the component B.

Optionally, the mass ratio of the component A to the component B in the reaction system is 35-80:100, preferably 40-75:100.

Still another aspect of the present invention provides the use of the polyurethane elastomer of the present invention in a glass encapsulation and an elastic gasket. The polyurethane elastomer of the present invention can also be widely used in other applications in which shock absorption and/or sealing are required, such as furnitures, office equipments, and automobile accessories or the like.

Still another aspect of the invention provides a polyurethane product comprising the polyurethane elastomer produced by the aforementioned process of the invention.

Preferably, the product is a glass encapsulation, an elastic gasket and/or a sealing element. The sealing element may be a sealing strip, a sealing ring, a sealing fin or the like.

It is unexpectedly found by repeated experiments that the addition of a hindered amine light stabilizer to the isocyanate component can avoid its adverse effects on the catalyst in the isocyanate reactive component (i.e., component B), thereby the storage stability of the polyurethane elastomer is increased, the production efficiency of the polyurethane elastomer is improved and the related costs are reduced. In addition, the polyurethane elastomer of the present invention has excellent physical properties and can be used in various applications to contribute to shock absorption, wear resistance and/or good sealing.

### EMBODIMENTS

The following terms used in the present invention have the following definitions or explanations.

The pbw refers to the parts by weight of respective components of the polyurethane reaction system;

The functionality refers to a value determined according to the formula in the field: functionality=hydroxyl number*molecular weight/56100; wherein the molecular weight is determined by GPC high performance liquid chromatography.

### Components of the Polyurethane Elastomer Reaction System

### A) Polyisocyanate

Any organic polyisocyanate can be used to prepare polyurethane elastomer with high resilience of the present invention. The organic polyisocyanate includes aromatic, aliphatic and cycloaliphatic polyisocyanates, and combinations thereof. The polyisocyanate can be represented by the formula R(NCO)n, wherein R represents an aliphatic hydrocarbonyl group having 2-18 carbon atoms, an aromatic hydrocarbonyl group having 6-15 carbon atoms, and an araliphatic hydrocarbonyl group having 8-15 carbon atoms, and n=2-4.

Useful polyisocyanates include, but are not limited to, vinyl diisocyanate, tetramethylene 1,4-diisocyanate, hexamethylene diisocyanate (HDI), dodecyl 1,2-diisocyanate, cyclobutane-1,3-diisocyanate, cyclohexane-1,3-diisocyanate, cyclohexane-1,4-diisocyanate, 1-isocyanato-3,3,5-trimethyl-5-isocyanatomethylcyclohexane, hexahydrotoluene-2,4-diisocyanate, hexahydrophenyl-1,3-diisocyanate, hexahydrophenyl-1,4-diisocyanate, perhydro-diphenylmethane-2,4-diisocyanate, perhydro-diphenylmethane-4,4-diisocyanate, phenylene-1,3-diisocyanate, phenylene-1,4-diisocyanate, diphenylethylene-1,4-diisocyanate, 3,3-dimethyl-4,4-diphenyldiisocyanate, toluene-2,4-diisocyanate (TDI), toluene-2,6-diisocyanate (TDI), diphenylmethane-2,4′-diisocyanate (MDI), diphenylmethane-2,2′-diisocyanate (MDI), diphenylmethane-4,4′-diisocyanate (MDI), mixture of diphenylmethane diisocyanate and/or diphenylmethane diisocyanate homologues with more rings, polyphenylpolymethylene polyisocyanate (polymeric MDI), naphthylene-1,5-diisocyanate (NDI), isomers of these polyisocyanates, any mixture of these polyisocyanates with their isomers.

Useful polyisocyanates also include isocyanates modified with carbodiimides, allophanates or isocyanates, preferably, but not limited to, diphenylmethane diisocyanates, carbodiimide modified diphenylmethane diisocyanate s, isomers of these polyisocyanates, mixtures of these polyisocyanates with their isomers.

As used herein, the polyisocyanate may include an isocyanate dimer, trimer, tetramer, or combinations thereof.

The isocyanate of the present invention preferably further includes an isocyanate prepolymer. In a preferred embodiment of the invention, the isocyanate is a mixture of MDI, polymeric MDI and prepolymers thereof. The mixture has a NCO content of 20-35 wt %, preferably 20-30 wt %. The NCO content is measured according to GB/T 12009.4-2016.

### B) Polyol

The polyol of the present invention may be a polyether polyol, a polyester polyol, a polycarbonate polyol, and/or mixtures thereof.

The polyol of the present invention is preferably one or more polyether polyols, wherein at least one polyether polyol is a polyol started with amine. The polyether polyol has a functionality of 2-8, preferably 3-6, and a hydroxyl number of 20-1200 KOH/g, preferably 20-800 mgKOH/g.

The polyether polyol can be prepared by known processes. Usually, it is prepared from ethylene oxide or propylene oxide with ethylene glycol, 1,2-propylene glycol, 1,3-propylene glycol, diethylene glycol, glycerol, trimethylolpropane, pentaerythritol, triethanolamine, toluenediamine, sorbitol, sucrose, or any combinations thereof as a starter.

Further, the polyether polyol may also be prepared by reacting of at least one akylene oxide containing an alkylene group of 2-4 carbon atoms with a compound containing 2-8, preferably but not limited to, 3-6 active hydrogen atoms or other reactive compounds in the presence of a catalyst.

Examples of the catalyst are alkali metal hydroxides such as sodium hydroxide, potassium hydroxide, or alkali metal alkoxides such as sodium methoxide, sodium ethoxide or potassium ethoxide or potassium isopropoxide.

Useful alkylene oxides include, but are not limited to, tetrahydrofuran, ethylene oxide, 1,2-propylene oxide, 1,2-butylene oxide, 2,3-butylene oxide, styrene oxide and any mixture thereof.

Useful active hydrogen atom-containing compounds include polyhydroxy compounds, preferably, but not limited to, water, ethylene glycol, 1,2-propylene glycol, 1,3-propylene glycol, diethylene glycol, trimethylolpropane, any mixture thereof, more preferably polyhydric, especially trihydric or higher polyhydric alcohols such as glycerol, trimethylolpropane, pentaerythritol, sorbitol and sucrose. Useful active hydrogen atom-containing compounds also include, but are not limited to, organic dicarboxylic acids such as succinic acid, adipic acid, phthalic acid and terephthalic acid, or aromatic or aliphatic substituted diamines such as ethylenediamine, diethylenetriamine, triethylenetetramine, propanediamine, butanediamine, hexamethylenediamine or toluenediamine

Useful other reactive compounds include ethanolamine, diethanolamine, methylethanolamine, ethylethanolamine, methyldiethanolamine, ethyldiethanolamine, triethanolamine, and ammonia.

The polyether polyol prepared with an amine as a starter includes a compound obtained by reacting an amine as a starter with an alkylene oxide compound.

As used herein, the term “alkylene oxide compound” generally means a compound having the following general formula (I):

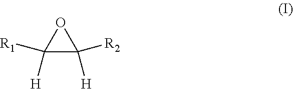

wherein R₁ and R₂ are independently selected from the group consisting of H, C₁-C₆ straight and branched alkyl groups, and phenyl and substituted phenyl groups.

Preferably, R₁ and R₂ are independently selected from the group consisting of H, methyl, ethyl, propyl and phenyl.

The process for preparing “alkylene oxide compound” is known to those skilled in the art. For example, it can be obtained by an oxidation reaction of an olefin compound.

Examples of the useful alkylene oxide compound of the present invention include, but are not limited to, ethylene oxide, 1,2-propylene oxide, 1,2-butylene oxide, 2,3-butylene oxide, and styrene oxide or mixtures thereof, particularly preferably a mixture of ethylene oxide and 1,2-propylene oxide.

As used herein, the term “alkylene oxide compound” also includes oxacycloalkane, examples of which include, but are not limited to, tetrahydrofuran and oxetane.

As used herein, the term “amine” refers to a compound containing a primary amino group, a secondary amino group, a tertiary amino group, or combinations thereof. Examples of compounds which can be used as the amine of the present invention include, but are not limited to, triethanolamine, ethylenediamine, toluenediamine, diethylenetriamine, triethylenetetramine, and derivatives thereof, preferably ethylenediamine, toluenediamine, particularly preferably toluenediamine

The polyurethane reaction system of the present invention comprises the following polyether polyols:
B1) an EO-terminated long-chain polyether polyol having a functionality of 3, a hydroxyl value of 17.5-35.5 mgKOH/g, preferably 22.5-35.5 mgKOH/g, and a weight average molecular weight of 4800-10000 g/mol, preferably 4800-8000 g/mol (as determined according to GB/T 21863-2008) in a content of 30-85 pbw, based on the total weight of the component B;
B2) optionally an EO-terminated long-chain polyether polyol having a functionality of 2, a hydroxyl value of 14.0-62.0 mgKOH/g, preferably 18.5-56.0 mgKOH/g, and a weight average molecular weight of 1800-8000 g/mol, preferably 2000-6000 g/mol (as determined according to GB/T 21863-2008) in a content of 0-55 pbw, preferably 1-50 pbw, based on the total weight of the component B.

### Catalyst

The catalyst of the present invention comprises at least one organotin catalyst. Preferably, the organotin catalyst is selected from one, two or more of the group consisting of alkyltin thiolates, alkyltin mercaptoacetates and long-chain alkyltin carboxylates. The organotin catalyst has a content of 0.01-0.5 pbw, preferably 0.01-0.3 pbw, based on the total weight of the component B.

Further, the catalyst of the present invention may further include a tertiary amine catalyst. Tertiary amine catalysts useful in the component B include, but are not limited to, triethylamine, tributylamine, dimethylbenzylamine, dicyclohexylmethylamine, dimethylcyclohexylamine, N,N,N,N′-tetramethyldiaminodiethyl ether, bis(dimethylaminopropyl)urea, N-methylmorpholine or N-ethylmorpholine, N-cyclohexylmorpholine, N,N,N′,N′-tetramethylethylenediamine, N,N,N′,N′-tetramethylbutanediamine, N,N,N′,N′-tetramethylhexane-1,6-diamine, pentamethyldiethylenetriamine, dimethylpiperazine, N-dimethylaminoethylpiperidine, 1,2-dimethylimidazole, 1-azabicyclo-[2.2.0]octane, 1,4-diazabicyclo[2.2.2]octane (Dabco), and alkanolamine compounds such as triethanolamine, triisopropanolamine, N-methyldiethanolamine and N-ethyl diethanolamine, dimethylaminoethanol, 2-(N,N-dimethylaminoethoxy)ethanol, N,N′,N″-tris(dialkylaminoalkyl)hexahydrotriazines such as N,N′,N″-tris(dimethylaminopropyl)-hexahydrotriazine, and triethylenediamine. Metal salts such as iron (II) chloride, zinc chloride, lead octoate are also suitable. Preferable are tin salts such as tin dioctoate, tin diethylhexanoate and dibutyltin dilaurate, and particularly a mixture of tertiary amines and organotin salts.

Preferably, the tertiary amine catalyst of the present invention is selected from one, two or more of the group consisting of triethylenediamine, N-ethylmorpholine, N,N,N′,N′-tetramethyl-ethylenediamine, dimethylaminopropylenediamine, N,N,N′,N′-tetramethyldipropylenetriamine or mixtures thereof and a weak acid-modified product of the above tertiary amine catalysts. The tertiary amine catalyst of the present invention has preferably a content of 0.05-2.5 pbw, based on the total weight of the component B.

### Light Stabilizer

Polyurethane products such as polyurethane elastomers for automobile glass encapsulation and elastic gaskets used in an outdoor environment may undergo photoaging degradation during use, greatly affecting their service life. Studies have shown that the gas products of photode gradation of polyurethane are carbon dioxide, carbon monoxide and hydrogen and the like. The main reason is that due to the action of light, the N—C bond and the C—O bond in the urethane group in the molecule are broken, and a group having a quinone-type configuration is formed, resulting in a significant yellowing of the polyurethane during photooxidation. The light stabilizers or UV absorbers can mask and absorb UV light, reducing direct damage to polyurethanes by light. The useful UV absorbers include benzotriazoles and benzophenones. Their molecular structural characteristics render them absorbing UV rays, being excited and undergoing an acid-base equilibrium reaction, and caning out proton transfer. As a result, the acidity of phenol group and alkalinity of carbonyl group increase. A chelating ring of intramolecular hydrogen bonds is formed. The excitation energy is converted effectively into harmless thermal energy by performing a reversible phenol-quinone tautomeric conversion cycle. Usable light stabilizers include free radical scavenging light stabilizers such as hindered phenols/amines and aromatic secondary amines. The light stabilizer selected for the present invention is a hindered amine light stabilizer in a content of 0.25-8.0 pbw, preferably 0.75-7.5 pbw, particularly preferably 1.2-7.0 pbw, based on the total weight of the component A.

Hindered amine light stabilizers (HALS) are a class of organic amine compounds with steric hindrance and are a new type of highly efficient light stabilizer. The hindered amine has a good inhibitory effect on photooxidative degradation of polymer (such as high molecular weight compound) and organic compound (i.e., photodegradation of polymer), and is a representative of free radical scavenging light stabilizers. Generally, hindered amine light stabilizers inhibit photooxidative degradation by various ways such as capturing free radicals, decomposing hydroperoxides, and transferring energy of excited molecules. Useful hindered amine light stabilizers include, but are not limited to, piperidine derivatives, imidazolone derivatives, and azacycloalkanone derivatives. Piperidine light stabilizer are further divided into two major classes: 2,2,6,6-tetramethylpiperidine derivatives and 1,2,2,6,6-pentamethylpiperidine derivatives. Preferably, the hindered amine light stabilizer of the present invention is selected from one, two or more of the group consisting of (2,2,6,6-tetramethyl-4-hydroxypiperidyl) benzoate, bis(2,2,6,6-tetramethyl-4-hydroxypiperidyl) sebacate, nitrilo-tris[(2,2,6,6-tetramethyl-4-hydroxypiperidyl) acetate] and N,N′-bis(2,2,6,6-tetramethylpiperidyl) hexamethylenediamine, tris(1,2,2,6,6-pentamethyl-4-hydroxypiperidyl) phosphite, bis(1,2,2,6,6-pentamethyl-4-hydroxypiperidyl) sebacate, bis(1,2,2,6,6-pentamethyl-4-hydroxypiperidyl) 2-ethyl-2-(4-hydroxy-3,5-di-tert-butylbenzyl)malonate and combinations thereof.

### Surfactant

In embodiments of the invention, the polyurethane reaction system of the invention further comprises a surfactant. The surfactant is preferably, but not limited to, an oxyethylene derivative of a siloxane. The surfactant has a content of 0.05-0.5 pbw, based on the total weight of the component B.

### Chain Extender

The chain extender of the present invention may be selected from a polyfunctional alcohol or amine compound with a low molecular weight containing a hydroxyl group or an amino group. Commonly used alcohol chain extenders are 1,4-butanediol (BDO), 1,6-hexanediol, glycerin, trimethylolpropane, diethylene glycol (DEG), triethylene glycol, neopentyl glycol (NPG), sorbitol, diethylaminoethanol (DEAE), or the like. The amine chain extenders include MOCA and liquid MOCA obtained by modification with formaldehyde, ethylenediamine (EDA), N,N-dihydroxy(diisopropyl)aniline (HPA), etc. There is also hydroquinone-di(β-hydroxyethyl) ether (HQEE). It is well known to those skilled in the art that the chain extender commonly used in the field of polyurethanes is a low-molecular-weight alcohol containing two or more hydroxyl groups, a compound containing an amino group or an imino group, or an ether alcohol. The present invention preferably comprises a low-molecular-weight polyol/alcohol amine chain extender including, but not limited to, propylene glycol, dipropylene glycol, butylene glycol, ethylene glycol, diethylene glycol, hexanediol, diethanolamine, triethanolamine, diisopropanolamine and triisopropanolamine, etc., in a content of 2.0-15.0 pbw, preferably 3.5-13.5 pbw, based on the total weight of the component B.

Further, the present invention optionally also comprises a low-molecular-weight diamine chain extender including, but not limited to, toluenediamine, diethyltoluenediamine (E-100), diphenylmethanediamine (MDA), dimethylthiotoluenediamine (E-300) and hexamethylenediamine. The low-molecular-weight diamine chain extender has a content of 0.5-6.5 pbw, based on the total weight of the component B.

### Crosslinking Agent

Suitable crosslinking agents for use in polyurethane elastomers which are well known to those skilled in the art can be selected as the crosslinking agent of the present invention, for example, a polyether polyol started with diamine Preferably, the component B of the polyurethane reaction system of the present invention further comprises a polyether polyol started with ethylenediamine having a hydroxyl value of 330-800 mgKOH/g, and a molecular weight of 250-800 g/mol (as determined according to GB/T 21863) in a content of 0.5-7.5 pbw, based on the total weight of the component B.

### Color Paste

In general, color paste refers to a semi-finished product made from pigments or pigments and fillers dispersed in a paint. Preferably, the component B of the polyurethane reaction system of the present invention further comprises a color paste in a content of 0.1-5.0 pbw, based on the total weight of the component B.

### Process for Producing a Polyurethane Elastomer

According to a first aspect of the present invention, a process for producing a polyurethane elastomer is provided, comprising producing the polyurethane elastomer by reacting a reaction system comprising the following components:
a component A, comprising:
   A1) one or more isocyanates;
   A2) at least one hindered amine light stabilizer in a content of 0.25-8.0 pbw, preferably 0.75-7.5 pbw, particularly preferably 1.2-7.0 pbw, based on the total weight of the component A;
a component B, comprising:
   B1) an EO-terminated long-chain polyether polyol having a functionality of 3, a hydroxyl value of 17.5-35.5 mgKOH/g, preferably 22.5-35.5 mgKOH/g, and a weight average molecular weight of 4800-10000 g/mol, preferably 4800-8000 g/mol (as determined according to GB/T 21863-2008) in a content of 30-85 pbw, based on the total weight of the component B;
   B2) optionally an EO-terminated long-chain polyether polyol having a functionality of 2, a hydroxyl value of 14.0-62.0 mgKOH/g, preferably 18.5-56.0 mgKOH/g, and a weight average molecular weight of 1800-8000 g/mol, preferably 2000-6000 g/mol (as determined according to GB/T 21863-2008) in a content of 0-55 pbw, preferably 1-50 pbw, based on the total weight of the component B;
   B3) a catalyst, comprising B3-1) at least one organotin catalyst.

The process for producing a polyurethane elastomer of the present invention preferably employs a reaction injection molding process (RIM). In the reaction injection molding process, after the components of a high-active polyurethane reaction system are mixed by a high-pressure impact mixing mechanism, said components are injected into a temperature-controlled mold in a very short period of time using a high-output, high-pressure metering device, and rapidly cured to produce a polyurethane article. During the production of a polyurethane product by a reaction injection molding process, the reaction mixture usually comprises component A and component B, wherein component A comprises a polyisocyanate and component B comprises an organic compound containing an active hydrogen atom, a suitable chain extender, a catalyst and/or other additives.

We have unexpectedly found by experiments that the addition of a hindered amine light stabilizer to the isocyanate component can avoid its adverse effects on the catalyst in the isocyanate reactive component (i.e., component B), thereby the storage stability of the polyurethane reaction system is increased and the curing speed is improved. Thus, the production efficiency of the polyurethane elastomer is enhanced and the related costs are reduced. In addition, the polyurethane elastomer of the present invention has excellent physical properties and can be used in various applications to contribute to shock absorption, wear resistance and/or good sealing.

### Polyurethane Elastomer

The polyurethane elastomer provided by the present invention is obtained by the aforementioned process for producing a polyurethane elastomer of the present invention.

In embodiments of the present invention, the mass ratio of the component A to the component B in the polyurethane reaction system of the present invention is preferably 35-80:100, preferably 40-75:100.

### Use of the Polyurethane Elastomer in a Glass Encapsulation and an Elastic Gasket

In still another aspect of the invention, the use of the polyurethane elastomer in a glass encapsulation and an elastic gaskets is provided.

In addition, the polyurethane elastomer of the present invention can also be used for automobile glass sealing strips, furniture sealing, or the like.

### Polyurethane Product

According to still another aspect of the present invention, a polyurethane product comprising the polyurethane elastomer produced by the aforementioned process of the present invention is provided.

Preferably, the product is a glass encapsulation, an elastic gasket and/or a sealing element. The sealing element may be a sealing strip, a sealing ring, a sealing sheet or the like.

### EXAMPLES

The raw materials (including sources), production and test methods of the examples are as follows:

Raw material 1: Arcol-1362 highly active polyether, Mw=6000, hydroxyl value 26.5 mgKOH/g, Covestro Polymers (China) Co., Ltd.

Raw material 2: Arcol-3553 highly active polyether polyol, Mw=5000, hydroxyl value 34.5 mgKOH/g, Covestro Polymers (China) Co., Ltd.

Raw material 3: Arcol-1026 highly active polyether polyol, Mw=4000, f=2, hydroxyl value 28 mgKOH/g, Covestro Polymers (China) Co., Ltd.

Raw material 4: 1,6-hexanediol, Japan Ube Chemical Co., Ltd.

Raw material 5: Desmophen4050E, polyether polyol with a diamine as a starter, Mw=350, f=4, hydroxyl value 630 mgKOH/g, Covestro Polymers Co., Ltd.

Raw material 6: diethyltoluenediamine, Albemarle Chemical Raw material 7: Color paste, BOMEX Chemical Co., Ltd.

Raw material 8: DC193 Surfactant, Air Product

Raw Material 9: NIAX UL-6 polyurethane catalyst of organotin type, Momentive

Raw Material 10: NIAX UL-29 polyurethane catalyst of organotin type, Momentive

Raw Material 11: NIAX UL-32 polyurethane catalyst of organotin type, Momentive

Raw Material 12: NIAX UL-38 polyurethane catalyst of organotin type, Momentive

Raw material 13: ZE-5 polyurethane catalyst of tertiary amine type, EVONIK

Raw material 14: Tinuvin B75 UV Stabilizer of hindered amine type, BASF (China) Co., Ltd.

Raw material 15: Desmodur 48IF46 Isocyanate, Covestro Polymers (China) Co., Ltd.

### Production of Examples and Comparative Examples (“Comp. Ex.”)

The isocyanate (plus the corresponding hindered amine light stabilizer in the case of Examples) was placed in a clean vessel, and stirred at 1000 rpm for 3 minutes with a stirrer to be homogeneously mixed, resulting in the component A. The polyether polyol, chain extender, surfactant, catalyst and other additives (plus the corresponding hindered amine light stabilizer in the case of Comparative Examples) were added to a clean vessel and stirred at 1000 rpm for 3 minutes with a stirrer to be homogeneously mixed, resulting in the component B. After mixing the components A and B by mechanical stirring at a temperature of about 40° C., the mixture was poured into a mold controlled to a temperature of about 100° C., and was cured and formed to give a polyurethane elastomer.

### Test Method for Performance:

After the components A and B of the polyurethane reaction system were prepared, they were sealed and placed in an oven at 50° C. for 7 days for a heat aging. After 7 days of heat aging, the components A and B were mixed in proportion and then cured and formed in a heating mold. Whether the mixture of the components A and B can be cured in the heating mold within 1 minute is used as a basis for evaluation of its storage stability.

| | Raw | Comp. | Comp. | Comp. | Comp. | | | | |
|---|---|---|---|---|---|---|---|---|---|
| | material | Ex. 1 | Ex. 2 | Ex. 3 | Ex. 4 | Ex. 1 | Ex. 2 | Ex. 3 | Ex. 4 |
| Isocyanate | Raw | 66.5 | 64.5 | 62.5 | 60.5 | 66.85 | 66.85 | 66.85 | 66.85 |
| reactive | material 1 | | | | | | | | |
| component B | Raw | 10 | 10 | 10 | 10 | 11 | 11 | 11 | 11 |
| | material 2 | | | | | | | | |
| | Raw | 5 | 5 | 5 | 5 | 5 | 5 | 5 | 5 |
| | material 3 | | | | | | | | |
| | Raw | 10 | 10 | 10 | 10 | 10 | 10 | 10 | 10 |
| | material 4 | | | | | | | | |
| | Raw | 2 | 2 | 2 | 2 | 2 | 2 | 2 | 2 |
| | material 5 | | | | | | | | |
| | Raw | 2 | 2 | 2 | 2 | 2 | 2 | 2 | 2 |
| | material 6 | | | | | | | | |
| | Raw | 2 | 2 | 2 | 2 | 2 | 2 | 2 | 2 |
| | material 7 | | | | | | | | |
| | Raw | 0.5 | 0.5 | 0.5 | 0.5 | 0.5 | 0.5 | 0.5 | 0.5 |
| | material 8 | | | | | | | | |
| | Raw | 0.12 | 0 | 0 | 0 | 0.12 | 0 | 0 | 0 |
| | material 9 | | | | | | | | |
| | Raw | 0 | 0.12 | 0 | 0 | 0 | 0.12 | 0 | 0 |
| | material 10 | | | | | | | | |
| | Raw | 0 | 0 | 0.15 | 0 | 0 | 0 | 0.15 | 0 |
| | material 11 | | | | | | | | |
| | Raw | 0 | 0 | 0 | 0.15 | 0 | 0 | 0 | 0.15 |
| | material 12 | | | | | | | | |
| | Raw | 0.5 | 0.5 | 0.5 | 0.5 | 0.5 | 0.5 | 0.5 | 0.5 |
| | material 13 | | | | | | | | |
| | Raw | 1.35 | 3.35 | 5.35 | 7.35 | 0 | 0 | 0 | 0 |
| | material 14 | | | | | | | | |
| The component B is stored in a sealed glass bottle and placed in an oven at 50° C. for | | | | | | | | | |
| 7 × 24 hours to be used later. | | | | | | | | | |
| Isocyanate | Raw | 0 | 0 | 0 | 0 | 2.47 | 3.47 | 3.47 | 3.75 |
| component A | material 14 | | | | | | | | |
| | Raw | 47.0 | 47.0 | 47.0 | 47.0 | 48.1 | 48.4 | 48.1 | 48.1 |
| | material 15 | | | | | | | | |

The component A is stored in a sealed glass bottle and placed in an oven at 50° C. for
7 × 24 hours to be used later.

| Process and | Temp. of raw | 40 ± 3° C. | | | | | | | |
|---|---|---|---|---|---|---|---|---|---|
| performance | materials | | | | | | | | |
| | stirrer | 7 cm turbo mixer, 2500 rpm, stirring time 7 seconds | | | | | | | |
| | Mold Temp. | 95° C. | | | | | | | |
| | Cured in 1 | No | No | No | No | Yes | Yes | Yes | Yes |
| | minute | | | | | | | | |

It was found from the above experimental results that in Comparative Examples 1 to 4, both the organotin catalyst and the hindered amine light stabilizer were added to the component B. The catalytic activity of the organotin catalyst was partly or completely lost after a heat aging at 50° C. for 7 days. The polyurethane reaction system could not be cured rapidly, and was not cured even after a long period of time. However, in Examples 1 to 4, the hindered amine light stabilizer was added to the component A. The catalytic activity of the organotin catalyst is not affected after the component B containing the organotin catalyst but without the hindered amine light stabilizer was subjected to a heat aging at 50° C. for 7 days. The polyurethane reaction system could be cured rapidly.

While the present invention has been described with its preferred embodiments as above, these embodiments are not intended to limit the present invention. It is obvious to those skilled in the art that various changes and modifications can be made without departing from the spirit and scope of the invention. Therefore, the protection scope of the present invention should be determined by the scope of the claims of the present patent application.

1. A process for producing a polyurethane elastomer, comprising producing the polyurethane elastomer by reacting a reaction system comprising the following components:
a component A, comprising:
A1) one or more isocyanates;
A2) at least one hindered amine light stabilizer in a content of 0.25-8.0 pbw, based on a total weight of the component A;
a component B, comprising:
B1) an EO-terminated long-chain polyether polyol having a functionality of 3, a hydroxyl value of 17.5-35.5 mgKOH/g, and a weight average molecular weight of 4800-10000 g/mol as determined according to GB/T 21863-2008 in a content of 30-85 pbw, based on a total weight of the component B;
B2) optionally an EO-terminated long-chain polyether polyol having a functionality of 2, a hydroxyl value of 14.0-62.0 mgKOH/g, and a weight average molecular weight of 1800-8000 g/mol as determined according to GB/T 21863-2008 in a content of 0-55 pbw, based on a total weight of the component B;
B3) a catalyst, comprising B3-1) at least one organotin catalyst.

2. The process as claimed in claim 1, wherein the hindered amine light stabilizer is selected from one, two or more of the group consisting of (2,2,6,6-tetramethyl-4-hydroxypiperidyl) benzoate, bis(2,2,6,6-tetramethyl-4-hydroxypiperidyl) sebacate, nitrilo-tris[(2,2,6,6-tetramethyl-4-hydroxypiperidyl) acetate] and N, N′-bis(2,2,6,6-tetramethylpiperidyl) hexamethylenediamine, tris(1,2,2,6,6-pentamethyl-4-hydroxypiperidyl) phosphite, bis(1,2,2,6,6-pentamethyl-4-hydroxypiperidyl) sebacate, bis(1,2,2,6,6-pentamethyl-4-hydroxypiperidyl) 2-ethyl-2-(4-hydroxy-3,5-di-tert-butylbenzyl)malonate, and combinations thereof.

3. The process as claimed in claim 1, wherein the B3-1) organotin catalyst is selected from one, two or more of the group consisting of an alkyltin thiolates, an alkyltin mercaptoacetate, a long-chain alkyltin carboxylates, and combinations thereof.

4. The process as claimed in claim 1, wherein the component B further comprises B4) at least one low-molecular-weight polyol/alcohol amine chain extender, which has a content of 2.0-15.0 pbw, based on the total weight of the component B.

5. The process as claimed in claim 1, wherein the component B further comprises B5) a polyether polyol started with ethylene diamine having a hydroxyl value of 330-800 mgKOH/g, a molecular weight of 250-800 g/mol as determined according to GB/T 21863-2008 in a content of 0.5-7.5 pbw, based on the total weight of the component B.

6. The process as claimed in claim 1, wherein the component B further comprises B6) a color paste in a content of 0.1-5.0 pbw, based on the total weight of the component B.

7. The process as claimed in claim 1, wherein a mass ratio of the component A to the component B in the reaction system is 35-80:100.

8. The process as claimed in claim 1, wherein the process is a reaction injection molding process.
